(19) United States
(12) Patent Application Publication
(10) Pub. No.: US 2006/0172890 A1
(43) Pub. Date: Aug. 3, 2006

(54) Liquid formulation of a plant growth regulator

(76) Inventors: Rathin Datta, Chicago, IL (US); Gerald J. Vasek, Westmont, IL (US); Linda M. Pasieta, Woodridge, IL (US)

Correspondence Address: WELSH & KATZ, LTD, 120 S RIVERSIDE PLAZA, 22ND FLOOR, CHICAGO, IL, 60606, US

(21) Appl. No.: 11/300,183

(22) Filed: Dec. 14, 2005

Related U.S. Application Data
(60) Provisional application No. 60/637,221, filed on Dec. 17, 2004.

(51) Int. Cl. A01N 43/54; A01N 25/02

(52) U.S. Cl. 504/240; 504/362

(57) ABSTRACT

A liquid concentrate formulation of a plant growth regulator, such as a gibberellin, dissolved in a blended solvent comprised of a C1 to C4 ester of lactic acid and a C2 to C6 polyhydric alcohol is disclosed. Use of the concentrate is also disclosed.

### CROSS-REFERENCE TO RELATED APPLICATION

This application is based on Provisional Application Ser. No. 60/637,221 filed on Dec. 17, 2004.

### TECHNICAL FIELD

The present invention relates to a liquid formulation of a plant growth regulator. In particular, the plant growth regulator, gibberellic acid, is formulated in a solvent comprised of C1 to C4 esters of lactic acid and polyhydric alcohols.

### BACKGROUND

The life cycle and overall development of most plants are managed by phytohormones known as plant growth regulators (PGRs). It is well known that PGRs can influence seed germination, growth, flowering, fruiting, dormancy and other plant processes. Thus, the use of PGRs can favorably impact the value of flowers, fruits, vegetables, ornamental plants, and other cash crops, and, as such, are widely used and favored by horticulturists.

The most common classes of PGRs include auxins, ethylene, cytokinins, and gibberellins. Auxins promote cell elongation in plant shoots and usually regulate other growth processes such as root initiation. Ethylene promotes the ripening of fruit. Cytokinins promote cell growth and delay the senescence of leaves. Gibberellins promote stem growth, affect the breaking of dormancy in certain buds and seeds, induce flowering, and stimulate pollen germination.

Gibberellins are one of the most popular PGR classes because of the broad range of positive effects that they can have on many types of plants. For example, gibberellins can be applied to seedless grapes to increase grape size and yield, and be used on citrus fruits, blueberries, and cherries to decrease or increase fruit set, size, cluster size, and delay rind aging. (University of California, Tulare County Cooperative Extension Publication TB14-00). Gibberellins are also used to trigger flowering of sweet potatoes in breeding programs, to help tomatoes set fruit at high temperatures in the tropics, and to stimulate flowering in tropical plants. (L. Wright, Gibberelllins-Plant Growth Hormones, Practical Hydroponics and Greenhouses, Issue 11, July/August 1993).

The effects of gibberellins are highly dependent on concentration and stage of plant growth. For example, the application of 0.02 micrograms of gibberellin promotes flowering of dwarf morning glory, but 2 to 20 micrograms inhibits flowering. Ten micrograms of gibberellin applied to pea seedlings nearly doubled shoot length if applied at 3 days old, but barely affected 9 day old seedlings. Notably, extremely small amounts of gibberellins may cause dramatic growth effects. For example, as little as 2 nanograms can trigger cone formation in a cypress tree shoot-tip. (Gibberellic Acid-3 Information Sheet, J. L. HUDSON, SEEDSMAN, STAR ROUTE 2, BOX 337, LA HONDA, CALIF. 94020-9733 USA, as excerpted from “Gibberellins”, Takahashi, N. B. Phinney and J. MacMillan Editors, 1991, Springer Verlag, New York).

Because gibberellins are very potent, they are used in very small concentrations and under very specific conditions. Thus, they need to be formulated so that they can be stored and used with minimum complications for the user. Gibberellins require a solvent or solid dispersant system as a carrier for horticulture applications. The solvent system cannot be aqueous as gibberellins hydrolyze in water.

In most commercial products, gibberellins are dissolved in an alcohol such as isopropanol, methanol, or ethanol at a concentration of about 4% (w/v). The commercial product is then diluted in water immediately prior to spray application.

There are manufacturing, storage, and transportation issues because of the flammability of this commercial product. For example, the alcohol formulation has to be manufactured with compatible equipment in explosion-proof facilities, transported under stringent flammability regulations, stored carefully in non-flammable storage containers and facilities. The alcohol formulations also need to be carefully checked for solvent losses and concentration changes due to volatility.

Recently, an emulsion of gibberellin in a lipophilic non-aqueous solvent mixed with lipophilic alkaline coupling agents was disclosed (U.S. Pat. No. 6,756,344). This formulation requires the use of complex chemicals that can lead to manufacturing complications and increased cost. The same flammability complications detailed above are also problematic for this emulsion as a flammable alcohol is the carrier.

Another recent patent application U.S. 200300008949 (Devisetty et al), described the use of a water soluble, granular, solid mixture of gibberellin with disaccharides, surfactants, polymeric binders. The synthesis of this solid gibberellin formulation involves a multistep process that requires homogenization, controlled mixing, extrusion, drying and sizing of the solid material. This solid gibberellin formulation also requires the use of complex chemicals that can lead to manufacturing complications and increased cost as detailed above.

The solid formulation also requires the need of accurate measurement and dispensing of solid particles, which is inherently more difficult than measuring and dissolving a liquid. Furthermore, many of the chemicals used in these formulations are petrochemically derived and do not have the U.S. Environment Protection Agency's (EPA) classification as non-toxic class 4A inert ingredient for pesticide and agricultural formulations.

Thus, there is an urgent need for a gibberellin formulation that is liquid, has low volatility, is non-toxic, is simple to manufacture, and presents no long-term storage problems The invention described hereinafter provides one solution to that need.

### BRIEF SUMMARY OF THE INVENTION

One aspect of the present invention contemplates a liquid plant growth promoter concentrate composition. The concentrate contains an effective amount of a plant growth regulator dissolved in a solvent blend of about 70 to about 90% by weight of a C1 to C4 aliphatic ester of lactic acid in conjunction with about 10 to about 30% by weight of a C2 to C6 polyhydric alcohol where the solvent blend has a flash point of about 140° F. or greater.

Preferably, the plant growth regulator is a gibberellin. More preferably, the plant growth regulator is gibberellic acid. It is preferred that the gibberellin be present in an amount of about 1 to about 20 percent by weight. Most preferably, the gibberellin is present in an amount of about 2 to about 8 percent by weight.

In another aspect of this invention, it is contemplated that the solvent blend of the concentrate comprises about 70 to about 90% by weight of a C1 to C4 ester of lactic acid and about 10 to about 30% by weight of a C2 to C6 polyhydric alcohol.

In one embodiment of this invention, the C1 to C4 ester of lactic acid is ethyl lactate. Alternatively, the C1 to C4 ester of lactic acid is n-butyl lactate. A still further contemplated aspect of this invention is where the C2 to C6 polyhydric alcohol is glycerol or propylene glycol or a mixture thereof.

Most preferably, this invention contemplates a liquid plant growth promoter concentrate composition comprising about 4 to about 6.5 percent gibberellic acid in a solvent blend of about 80 percent (w/w) ethyl lactate and 20 percent (w/w) percent propylene glycol wherein the solvent blend has a flash point about 147° F.

An aqueous composition containing about 0.5 to about 5 grams per fluid ounce of diluted concentrate is also contemplated. That concentration comes out to be about 0.017 to about 0.17 g/ml. One fluid ounce is about 29.6 ml.

The present invention has several benefits and advantages.

One benefit is that the gibberellin formulation is comprised simply of gibberellin and lactate esters and glycerol. No complex chemicals or costly ingredients are required for synthesis.

Another benefit is that the gibberellin formulation is stable, has low volatility, and a high flash point. These factors are critical to both manufacturing and safety issues.

Yet another benefit is that the preferred ingredients are non-toxic and environmentally benign. Ethyl lactate and glycerol are EPA approved as a class 4A inert. Propylene glycol is approved for wide use as a humectant and in food processing applications.

Still yet another benefit is that the primary ingredients, lactate esters and glycerol are derived from renewable carbohydrates via fermentation processes or from plant derived fats and oils respectively as compared from petroleum products.

Still further benefits and advantages of the invention will be apparent to the worker of ordinary skill from the disclosure that follows.

### DETAILED DESCRIPTION OF THE INVENTION

The present invention provides an efficient, economical and environmentally friendly formulation for the delivery of plant growth regulators (PGRS) for horticultural purposes. This formulation is based on the discovery that the contemplated solvent blends have the ability to dissolve significant quantities of PGRs such as GA, are stable solutions, display substantially no phytotoxicity, and are effective when tested in field applications. The primary blend ingredients, lactate esters and glycerol are derived from renewable carbohydrates via fermentation processes or from plant derived fats and oils, respectively, and are readily available.

The present invention provides a liquid plant growth promoter concentrate composition comprising an effective amount of a PGR such as a gibberellin dissolved in a solvent blend of a C1 to C4 ester of lactic acid and a C2 to C6 polyhydric alcohol. The solvent blend has a flash point of about 140° F. or greater. Although any plant growth promoter can be used in this composition, such as an auxin, a cytokinin, and a gibberellin, to name just a few, the preferred plant growth promoter is a gibberellin. More preferably, the plant growth promoter is gibberellic acid (GA). A mixture of plant growth promoters can be used as well.

An effective amount of a PGR such as gibberellin used in the present composition can be very small or quite large, depending on the particular species of plant involved and its stage of development. Preferably, the PGR such as gibberellin is present in an amount of about 1 to about 20 percent by weight. A more preferable gibberellin concentration is about 2 to about 8 percent by weight. Most preferably, the concentration of gibberellin is about 4 to about 6.5 percent as gibberellic acid.

As for the solvent blend composition, it is comprised of about 70 to about 90% by weight of a C1 to C4 ester of lactic acid and about 10 to about 30% by weight of a polyhydric alcohol. A preferred C1 to C4 ester of lactic acid is ethyl lactate. Another preferred C1 to C4 ester of lactic acid is n-butyl lactate. Aliphatic lactate esters, such as ethyl lactate are available from Vertec BioSolvents, Inc. of Downers Grove, Ill. under the Trade name of VertecBio EL. This product is also approved by the EPA as a class 4A inert for pesticide formulations, as is glycerol. The blended solvent is also readily available as VertecBio EL 104.

Another part of the solvent blend is the C2 to C6 polyhydric alcohol. Preferably, the polyhydric alcohol is glycerol, propylene glycol, or a mixture thereof. Additional illustrative alcohols include ethylene glycol, erythritol, threitol, pentaerythritol, mannitol, and sorbitol.

A contemplated solvent blend is substantially free of added water and contains only a few percent water as can be present in commercial grades of the polyhydric alcohol and the lactic acid ester. The amount of water present in a contemplated concentrate is typically less than about 10 percent by weight and preferably less than about 5 percent by weight.

An important advantage of this solvent blend is its high flash point thereby making the manufacturing, storage, and transportation much simpler. Preferably, the flash point of the solvent blend is about 140° F. or greater. More preferably, the flash point is about 145° F. or greater.

A most preferred embodiment of this invention comprises a liquid plant growth promoter concentrate composition comprising about 4 to about 6.5 percent gibberellic acid dissolved in a solvent blend of about 80 percent (w/w) ethyl lactate and 20 percent (w/w) percent glycerol wherein the solvent blend has a flash point of about 153° F.

An aqueous plant growth promoter composition (or solution) containing about 0.5 to about 5 grams per fluid ounce of diluted concentrate is also contemplated. That concentration comes out to be about 0.017 to about 0.17 g/ml. One fluid ounce is about 29.6 ml. More preferably, the amount of plant growth promoter present in the diluted composition is about 0.067 to about 0.1 g/ml.

A contemplated concentrate is diluted with water to prepare an aqueous plant growth promoter solution that is sprayed or otherwise applied to plants (on the leaves or about the roots or both), seeds, planted seeds or earth prepared to receive seed. It is preferred to use the diluted solution within a few hours of its preparation to avoid decomposition of a plant growth promoter such as a gibberellin.

It is to be understood that various other materials can be added to the solvent blend that would be advantageous in the manufacturing and storage of the composition such as a chemical stabilizer or that would be advantageous in the general horticulture area'such as fertilizers and the like.

### EXAMPLES

### Example 1

### Properties of GA in Solvent Blends

Gibberellic acid (GA) of 92% purity as a dry powder was used in these laboratory studies. The solvents and reagents were of reagent grade purity.

The solubility of GA in ethyl lactate alone at room temperature was determined to be approximately 2% (w/w) and mild heating to 60° C. did not increase the dissolution. Glycerol and propylene glycol were able to dissolve a small amount of GA but these solutions were very viscous and difficult to mix.

A 4% w/w GA formulation was prepared by blending 80:20 (w/w) ethyl lactate and propylene glycol at room temperature with GA, then gently heating the formulation to a moderate temperature of about 60° C. The flash point of this formulation was determined to be 147° F.

A 4% w/w GA formulation was prepared by blending 80:20 (w/w) ethyl lactate and glycerol at room temperature with GA, then gently heating the formulation to a moderate temperature of about 60° C. The flash point of this formulation was determined to be 153° F.

These results showed that GA was more soluble (twice as much) in the solvent blends than in ethyl lactate alone. Also, the GA was easier to dissolve in the solvent blends because they were not as viscous as the single solvents. Moreover, the solvent blends had high flash points. A flash point above 140° F. is very desirable because there are less regulatory restrictions on manufacturing, transportation, and storage.

### Example 2

### Properties of GA in Solvent Blends

Solvent blends of 80:20 and 70:30 (w/w) ethyl lactate and glycerol, respectively, were prepared and about 6.4 to about 6.5% w/w GA was added at room temperature and then gently heated to a moderate temperature of about 60° C. These solutions were stored at three different temperatures; at room temperature, in a refrigerator at 4° C., and a freezer at −20° C. No precipitation or phase separation was observed in a week at all temperatures. In fact, the refrigerated sample was still a stable solution after one year of storage.

The specific gravity of the solvent blend (80:20) is 1.08. Based on this and a 6.26% (w/w) solution of GA, a liquid formulation with a measured deliverable dosage of 2 grams of GA per fluid ounce was readily achieved.

### Example 3

### Tests for Potential Phytotoxicity of Sprayed Aqueous Solvents

The potential for phytotoxicity (plant injury) by spraying 1 to 2% aqueous solutions of ethyl lactate and solvent blends with ethyl lactate, as well as other ingredients such as glycerol and soy methyl esters was evaluated in field tests with apple trees and in greenhouse tests with corn, green bean, cucumber, tomato, ryegrass and hosta seedlings. The results showed no evidence of phytotoxicity for any of these solvent blends.

In field tests with grapes this GA formulation with the solvent blend showed no adverse effects and gave the same results as to yield and performance as the control that used the standard 4% GA in IPA formulation.

Each of the patents and articles cited herein is incorporated by reference. The use of the article “a” or “an” is intended to include one or more.

The foregoing description and the examples are intended as illustrative and are not to be taken as limiting. Still other variations within the spirit and scope of this invention are possible and will readily present themselves to those skilled in the art.

What is claimed:

1. A liquid plant growth promoter concentrate composition comprising an effective amount of a plant growth promoter dissolved in a solvent blend that comprises about 70 to about 90% by weight of a C1 to C4 ester of lactic acid and about 10 to about 30% by weight of a C2 to C6 polyhydric alcohol, and wherein the solvent blend has a flash point of about 140° F. or greater.

2. The composition according to claim 1 wherein the plant growth promoter is a gibberellin.

3. The composition of claim 1 wherein the gibberellin is present in an amount of about 1 to about 20 percent by weight.

4. The composition according to claim 1 wherein the flash point of the solvent blend is greater than about 145° F.

5. The composition of claim 1 wherein the solvent blend comprises about 80% by weight of a C1 to C4 ester of lactic acid and about 20% by weight of a C2 to C6 polyhydric alcohol.

6. The composition of claim 1 wherein the C1 to C4 ester of lactic acid is ethyl lactate.

7. The composition of claim 1 wherein C1 to C4 ester of lactic acid is n-butyl lactate.

8. The composition of claim 1 wherein the C2 to C6 polyhydric alcohol is glycerol.

9. The composition according to claim 1 wherein the C2 to C6 polyhydric alcohol is propylene glycol.

10. The composition according to claim 1 wherein the C2 to C6 polyhydric alcohol is a blend of glycerol and propylene glycol.

11. A liquid plant growth promoter concentrate composition comprising about 1 to about 20 percent by weight of a gibberellin dissolved in a solvent blend that comprises about 80% by weight of a C1 to C4 ester of lactic acid and about 20% by weight of a C2 to C6 polyhydric alcohol, and wherein the solvent blend has a flash point of about 145° F. or greater.

12. The composition of claim 11 wherein the gibberellin is present in an amount of about 2 to about 8 percent by weight.

13. The composition of claim 12 wherein the gibberellin is gibberellic acid.

14. The composition of claim 11 wherein the gibberellic acid is present in an amount of about 4 to about 6.5 percent by weight.
